(19) United States
(12) Patent Application Publication
(10) Pub. No.: US 2018/0021603 A1
(43) Pub. Date: Jan. 25, 2018

(54) HYDRAULIC IMPLEMENT

(71) Applicant: LUKAS Hydraulik GmbH, Erlangen (DE)

(72) Inventors: Tammy HORNE, Gastonia, NC (US); Carsten SAUERBIER, Lauf (DE); Christopher JAQUES, Fort Mill, SC (US)

(21) Appl. No.: 15/546,228

(22) PCT Filed: Jan. 26, 2015
(86) PCT No.: PCT/EP2015/051510

§ 371 Date: Jul. 25, 2017

(51) Int. Cl. A62B 3/00; B25B 28/00

(52) U.S. Cl. CPC A62B 3/005; B25B 28/00; F15B 15/06

(57) ABSTRACT

A hydraulic implement (1) for portable use includes a hydraulic pump (2), a pump housing (10), a hydraulic cylinder (3) with a piston rod (11), a hydraulic tank (4), hydraulic lines, a compensating device, a manually operable hydraulic control valve (8), a rechargeable battery (9) which is accommodated on the implement (1), and two tool halves (16, 17) that are connected to the piston rod (11) via pivoting arms (12, 13). Each tool half (16, 17) has a wall section (20, 21) that extends perpendicularly to the extension of the longitudinal axis of the piston rod (11). When the tool halves are closed, both wall sections (20, 21) together form a flattened end region (24) that runs perpendicularly to the extension of the longitudinal axis of the piston rod (11).

The present invention relates to a hydraulic implement for portable use according to the preamble of claims 1, 10, and 20.

### TECHNICAL BACKGROUND

Hydraulic implements for portable use are usually used by fire departments for rescue operations. They comprise an electrically operated hydraulic pump, a rechargeable battery accommodated in the device, and pivoting tool halves. These are used above all for cutting body parts and for spreading and/or forcing open vehicle doors. Such devices can also be used in disaster relief, for example for rescuing victims. However, these devices are often very heavy and have relatively large dimensions, so that they are oftentimes poorly suited to mobile, universal use. What is more, the possible applications of such devices are limited by the type of tool halves used.

### PRINTED PRIOR ART

One implement according to the preamble of claim 1 is known from data sheet SC 357 2 from LUKAS Hydraulik GmbH. This known implement represents a rescue device with a cutting and spreading function and comprises two tool halves having a toothed cutting profile and forming a triangular spreading profile on the front side. The cutting profile ends at the spreading jaw. A hydraulic unit and hydraulic circuit is known from EP 0 419 810 A1. This hydraulic unit is operated by means of a manual pump unit. A compensating device in the form of a diaphragm and the hydraulic tank are located in the extension of the cylinder housing.

DE G 92 15 062 discloses a spreading tool with exchangeable spreading jaws that form a triangular spreading profile. The spreading jaws are locked by means of removable bolts on the pivoting arms sitting on the device, so these spreading jaws can only be exchanged very slowly.

U.S. Pat. No. 8,727,317 B2 discloses an implement in the form of a hydraulic spreader for passenger cars that have been in a collision which has a hydraulic cylinder, a pump, and a rechargeable battery. The hydraulic tank and the compensating device are arranged around the hydraulic cylinder.

### OBJECT OF THE PRESENT INVENTION

It is the object of the present invention to provide an implement of this generic type which enables a broadened range of application.

### How the Object is Achieved

The above object is achieved by a hydraulic implement according to the features of claim 1. Expedient embodiments of the invention are claimed in the subclaims.

By virtue of the fact that each tool half has a wall-like portion extending perpendicular to the extension of the longitudinal axis of the piston rod and the two portions form together a common, flattened front region running perpendicular to the extension of the longitudinal axis of the piston rod when the two tool halves are in the closed state, it is possible to advantageously use the implement to spread open gaps in house doors or windows. In comparison to conventional handheld tools, the implement according to the invention thus enables residences or buildings to be entered very quickly using the specially designed tool.

The flattened front region is advantageously arranged so as to be laterally offset in relation to the extension of the longitudinal axis of the piston rod. This enables the flattened front region to be introduced without any difficulty into a door gap even in the event of unfavorable space conditions—for example, if the door gap is located in immediate proximity to a door frame.

Alternatively or in addition, the flattened front region can be oriented so as to run skew to the extension of the longitudinal axis of the piston rod. As a result, the flattened front region can be introduced more easily into a door gap in unfavorable space conditions.

The two tool halves widen toward the piston rod. Preferably, one tool half comprises a wall region that runs at an angle to the plane of the flattened front region and intersects with the midline of the extension of the piston rod. This wall region supports the opening movement of the door or window.

The tip of the flattened front region expediently has a chamfer. This facilitates penetration of the flattened front region into an especially narrow door gap. Particularly, the chamfer also makes it easier to pound the flattened front region into a narrow door gap. By virtue of the fact that the tool halves are arranged in the region of the flattened front region such that they engage in or over one another, an especially narrow, flattened front region can be achieved, since the tool halves to not “double up” on each other in this region. On the other hand, however, due to the special shape of the first tool half, sufficient force can be applied to the door gap.

The tool according to the invention advantageously has at least one flat, anvil-like wall portion at its end opposite the front region. This wall portion serves as a contact surface for actively driving the flattened front region of the tool into the door gap, for example using an axe or a hammer. This can be very advantageous if the gap is too small in order to penetrate into it with the flattened front region. Through the application of an external force, quick penetration into the door gap is possible nonetheless.

Advantageously, at least one of the flat wall portions has a contour. A crowbar can be placed on this contour, thus enabling the crowbar to be struck with a hammer or an ax. The contour offers the advantage that the crowbar does not slip from the wall portion under the force effect of the hammer or ax. A knurl can also be provided as a contour.

Another expedient embodiment of the implement is characterized in that the tool halves also have a cutting profile. Using this cutting profile, it is possible, for example, to quickly cut through a security chain on the door after the door is broken open.

The above object is also achieved particularly by a hydraulic implement with the features of claim 10, which are also claimed independently. Advantageously, the tool halves can be attached to additional tool halves. This enables the especially quick exchanging of the tools.

For example, the aforedescribed door-opening tool can be designed such that it can be attached to these additional tool halves. The two tool halves (namely, those which are attached as well as those to which attachment is performed) each have a tool function—for example, a tool function of crushing, spreading, cutting, or the like.

In order to enable the tools to be exchanged as quickly as possible, a coupling is expediently provided for attaching and detaching the first tool halves from the second tool halves that comprises a locking element that can be locked and unlocked by means of a large-surface, plate-shaped actuation element. The actuation element can also be operated with thick gloves, thus ensuring the quick exchanging of tools.

The locking element is spring-loaded and engages in a hole on the second tool half when the first tool half is attached to the second tool half. After the attachment of the first tool half to the second tool half, the spring holds the locking element in position. It this way, it is ensured that the tool halves are not separated from one another during use. Through actuation of the actuation element, the tool halves can be quickly separated from one another or pulled off.

The actuation element expediently has a preferably annular projection that is arranged opposite a corresponding hole. Upon actuation of the actuation element, the projection is pushed into the hole and the locking element located there is sunk into the hole. This enables trouble-free operation.

It is advantageous for a chamfered edge to be located at the beginning of the second tool half. Upon attachment of the second tool halves to the first tool halves, the chamfered edge has the effect that the locking element is sunk into the hole against the force of the spring. The locking element then remains in this hole until the second tool half has been pushed so far into the first tool half that the locking element has reached the hole located in the coupling. The locking element is pressed upward by the force of the spring, thereby locking the tool halves in place.

Expediently, the tool halves acting as a receptacle have a—preferably toothed—cutting profile.

Advantageously, the attached tool halves also have a—preferably rectilinear—cutting profile. This is especially advantageous, for example, if a cable and/or a security chain of a door has to be cut through.

It is especially advantageous if the cutting profile of the second, attached tool halves extends the cutting profile of the first tool halves.

Expediently, the attached tool halves form a conventional triangular spreading profile.

It is also advantageous if the attached tool half has an inner-lying contact surface and the cutting profile projects over the plane of the contact surface. In this way, it is ensured that the operator does not have to first search for the cutting profile, but rather the cutting profile is already located in the tip of the tool half. The inner-lying contact surface offers the additional possibility of a crushing function.

It is advantageous if the cutting profile extends into the tip of the second tool half, so that a cable can be severed with no delay without aligning the tip of the implement.

Another expedient embodiment of the implement which is also claimed independently consists in integrating the compensating device and the hydraulic tank together in the pump housing. This guarantees an especially space-saving and weight-reducing design of the implement.

It is expedient if the pump housing has a lid that forms a space together with the pump housing in which the compensating device is located—in the form of a rubber diaphragm, for example—and can extent into this space depending on the specific application. Structurally speaking, this embodiment is especially simple.

It is expedient for a holding fixture for an illumination unit to be located on the pump housing. This is expedient when the implement is used in total darkness, for example by a special task force or in poor visibility conditions. In this way, the operator can be assured of a certain level of illumination of the workspace.

The illumination unit preferably has its own power supply. The separation of the power supply has the advantage that the rechargeable battery for the pump cannot be used up by the illumination unit.

### DESCRIPTION OF THE INVENTION ON THE BASIS OF EXEMPLARY EMBODIMENTS

Expedient embodiments of the present invention are explained in further detail below with reference to drawings.

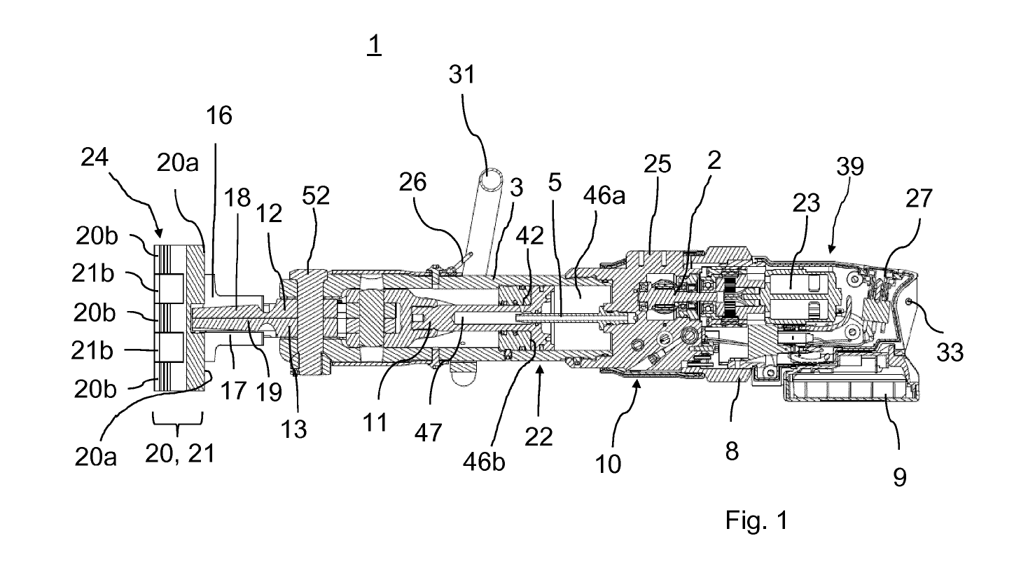

FIG. 1 shows a longitudinal sectional view of a first embodiment of a hydraulic implement according to the invention;

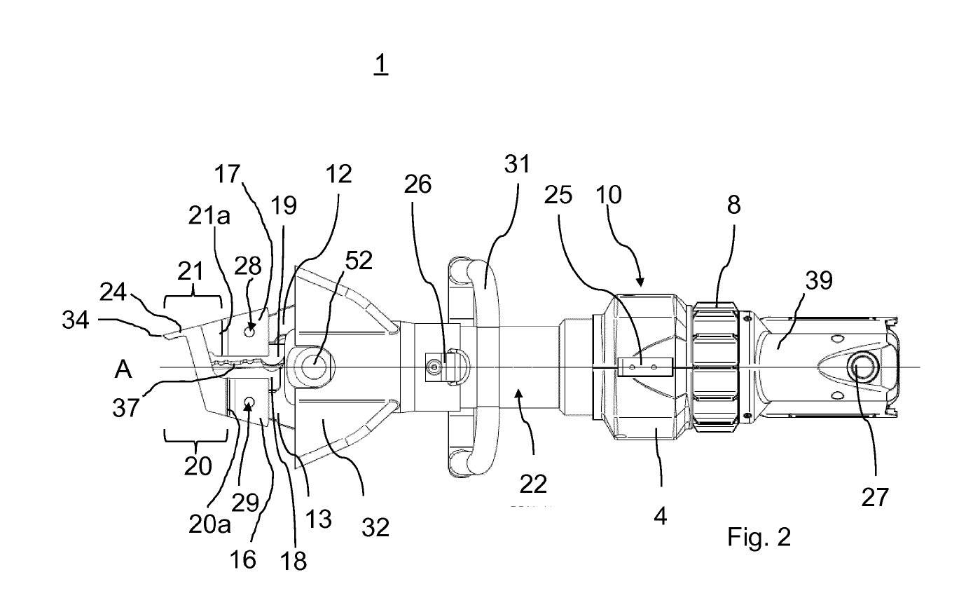

FIG. 2 shows a top view of the embodiment of the hydraulic implement according to FIG. 1;

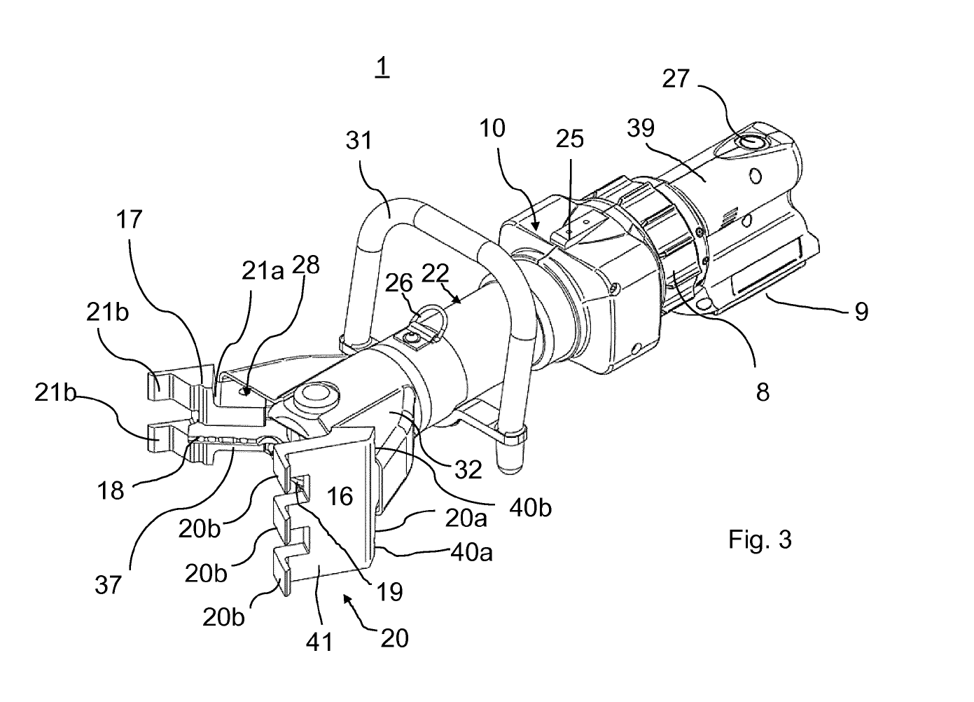

FIG. 3 shows a perspective view of the embodiment of the hydraulic implement according to FIG. 1 with opened tool halves;

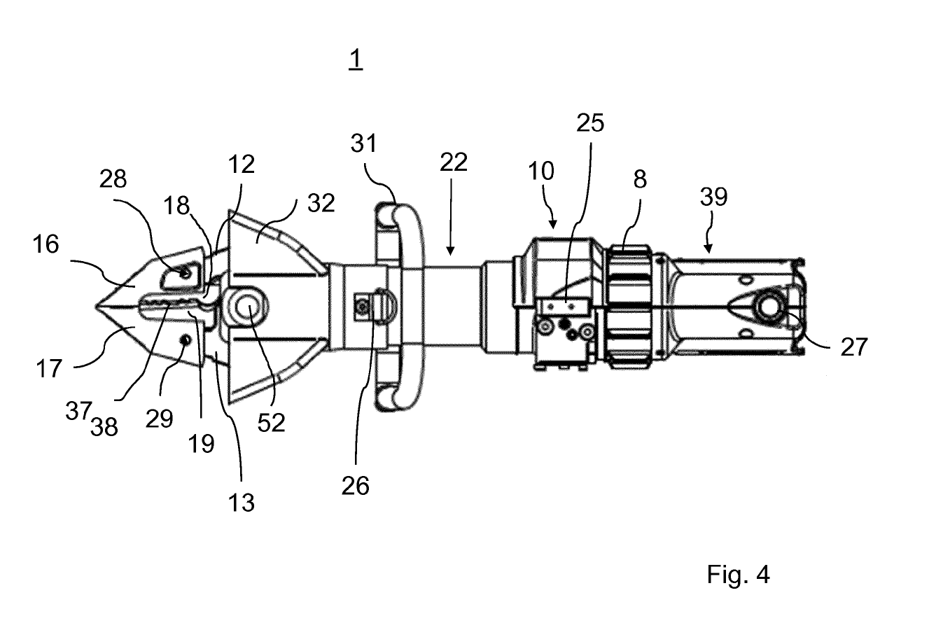

FIG. 4 shows a top view of a second embodiment of the hydraulic implement according to the invention;

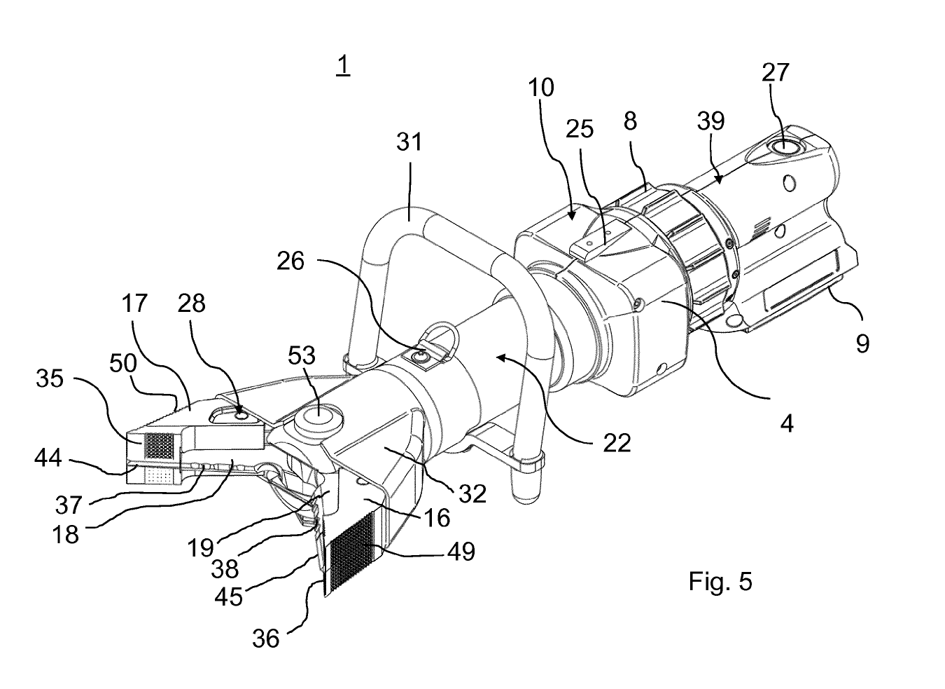

FIG. 5 shows a perspective view of the embodiment of the hydraulic implement according to FIG. 4 with opened tool halves;

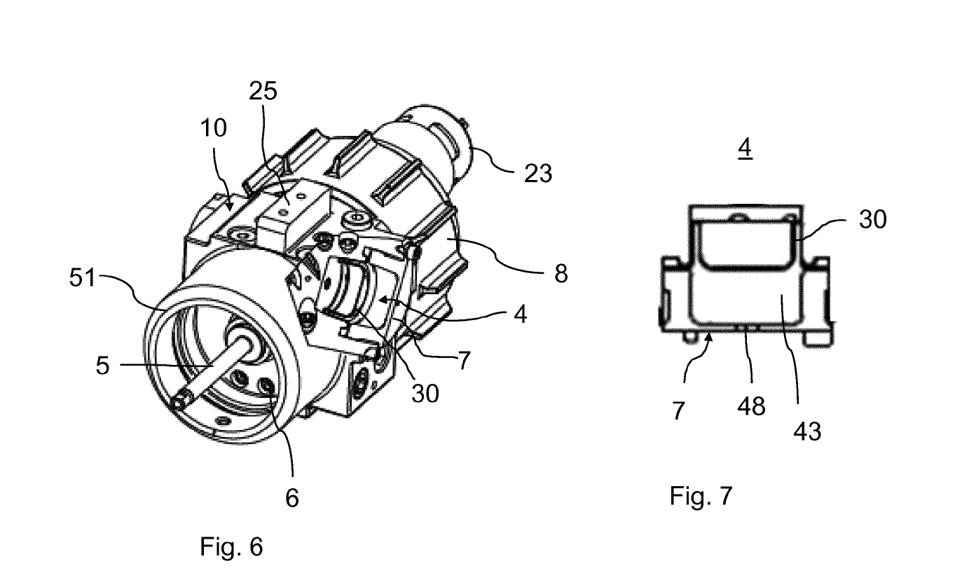

FIG. 6 shows a perspective view of the pump housing including the control valve of the hydraulic implement according to the invention;

FIG. 7 shows a sectional view through the hydraulic tank of the hydraulic implement according to the invention;

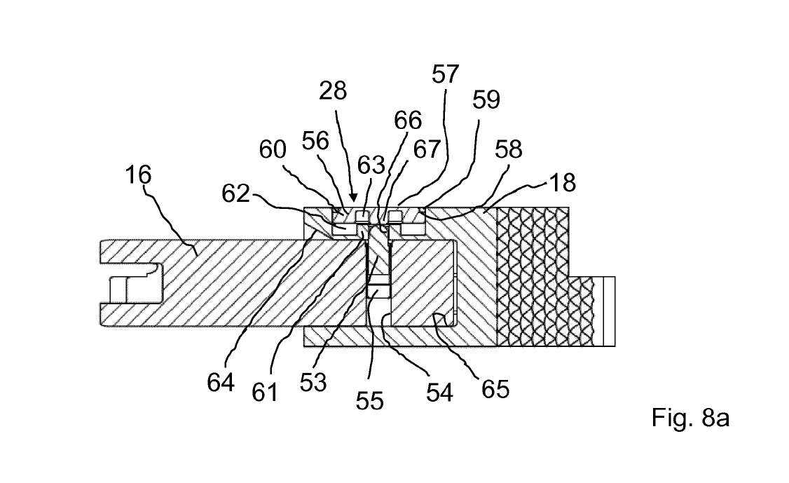

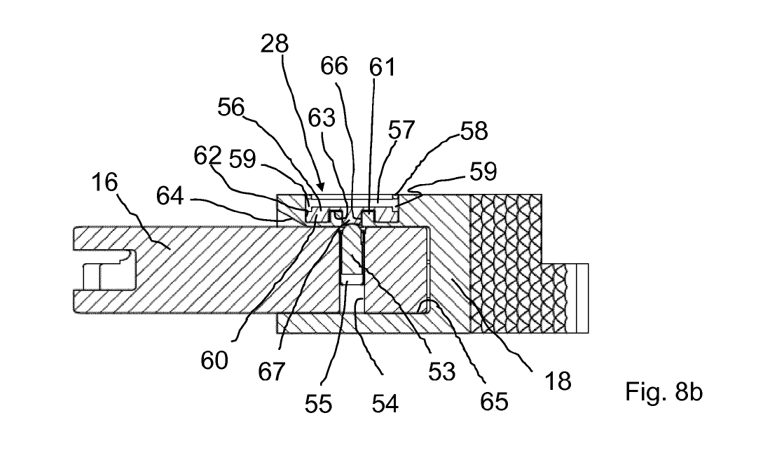

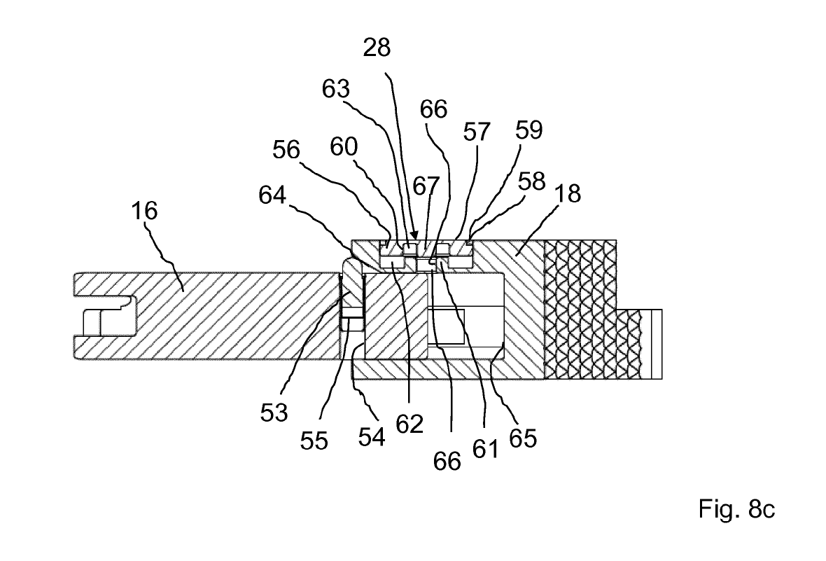

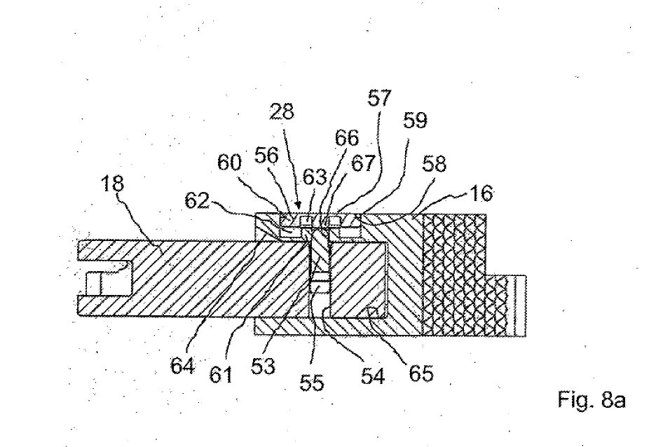

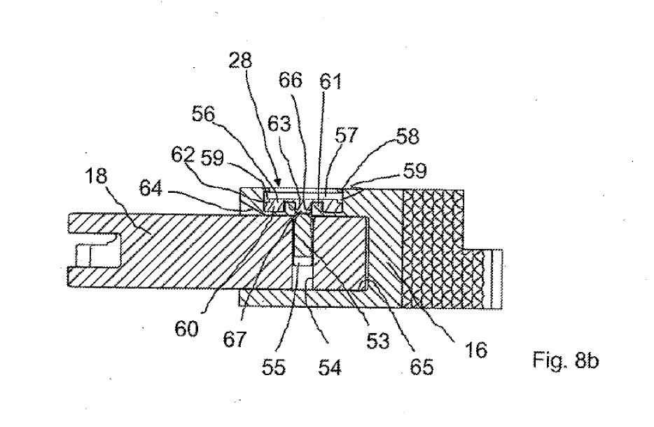

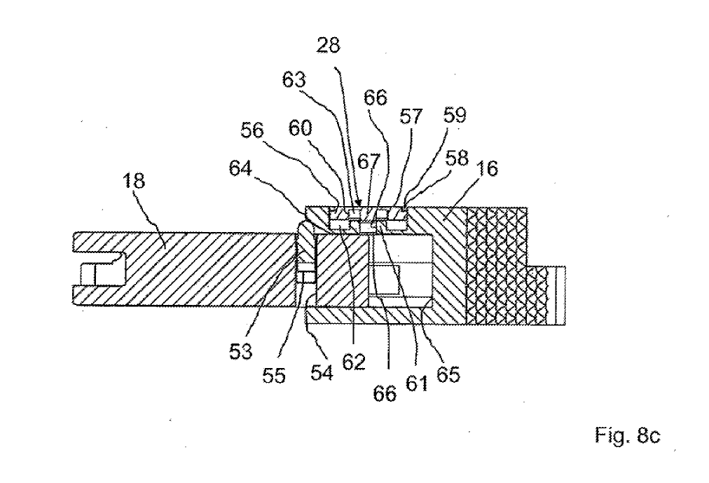

FIG. 8a shows a sectional view in the region of the connection between first tool half and second tool half in the locked state;

FIG. 8b shows a sectional view in the region of the connection between first tool half and second tool half in the unlocked state; and

FIG. 8c shows a sectional view in the region of the connection between first tool half and second tool half with the second tool half partially removed.

Reference number 1 in FIG. 1 refers to the portable hydraulic implement according to the invention in its entirety. The implement 1 comprises a motor housing 39, a pump housing 10, a cylinder housing 22, and a front-side door-opening tool driven by the implement. An electric motor 23 for driving a hydraulic pump 2 that is accommodated in the pump housing 10 is located in the motor housing 39. To switch the implement 1 on and off, a main switch 27 is provided on the motor housing 39. A rechargeable battery 9, which is inserted in a manually detachable manner into a slot on the underside of the motor housing 39, serves as the power source.

Reference symbol 8 refers to a control valve in the form of a so-called “star valve,” which is used to control the direction of flow of the hydraulic fluid and thus the working movement of the tool (opening and closing).

The cylinder housing 22 contains a first cylinder space 46a as well as the second cylinder space 46b, which are separated from one another by the piston of a piston rod 11. In FIG. 1, the piston is located in its forward end position. To enable hydraulic fluid to travel from the hydraulic pump 2 to the second cylinder space 46b, a hollow rod 5 is arranged securely on the pump housing 10. A hole 47 for receiving the hollow rod 5 during the movement of the piston rod 11, as well as a flow opening 42 for the hydraulic fluid into the second cylinder space 46b, are provided in the piston rod 11.

The end of the piston rod 11 facing away from the pump housing 10 is connected via a reversing mechanism to two pivoting arms 12, 13, which spread out or pivot toward each other depending on the direction of motion of the piston rod 11. Reference number 52 refers to a retaining pin, which simultaneously forms the pivot axis of the two pivoting arms 12, 13.

At their end facing away from the pin 52, the two pivoting arms 12, 13 are embodied as tool halves 18, 19 to which additional tool halves 16, 17 are attached.

In the exemplary embodiment, the additional tool halves 16, 17 form together a door-opening tool.

FIG. 1 also shows harness supports 26, 33, which are used to fasten a harness (not shown) to the implement 1. Furthermore, a handle 31 is provided on the implement 1.

Reference number 25 refers to a holding fixture for an illumination unit (not shown). The illumination unit is preferably equipped with its own power supply.

The two tool halves 16, 17 form a tool for opening doors or windows. For this purpose, the second tool halves 16, 17 each comprise a perpendicularly extending wall-like portion 20, 21 with changing wall thicknesses. When the two tool halves 16, 17 are in the closed state, these two portions 20, 21 form on their front side a flattened front region 24 running perpendicular to the extension of the longitudinal axis of the piston rod 11. The front region 24 is used for insertion into the gap of a house door or house window. It enables the door-opening tool to be introduced into the gap with optimal force transmission. On their rear side opposite the flattened front region 24, the two tool halves 16, 17 have flat wall portions 20a, 21a with increased material thickness that are used as a contact surface for a hammer (not shown) or an axe (not shown) or as a contact extension for a rod or crowbar (also not shown).

In the embodiment according to FIG. 1, the flattened front region 24 is formed by several flattened wall portions 20b and 21b, respectively, per tool half 16, 17, which engage flush in one another in the manner of fingers when the tool halves 16, 17 are closed.

This results in the formation of a flattened front region 24 whose vertical is greater than the diameter of the cylinder housing 22. The door-opening tool thus offers ideal force transmission into the gap of a door or window.

According to FIG. 2, the flattened front region 24 of the two tool halves 16, 17 is arranged so as to be offset laterally in relation to the longitudinal axis A of the implement 1 or the piston rod 11. In addition, the flattened front region 24 can be somewhat sloped toward the extension of the longitudinal axis A as needed. This design makes it possible to effectively use the implement 1 even in tight space conditions, for example on a door frame that is close to a door gap.

The front tip of the flattened front region 24 has a chamfer 34 that enables the tip of the tool to be pressed into a narrow gap of a door or window under application of force.

A hammer or an axe can be struck on the wall portions 21a and 20a running vertical in relation to the drawing plane of FIG. 2, or a contact extension provided for this purpose can be used. Reference symbol 32 refers to a cover for the two pivoting arms 12, 13 of the implement.

FIG. 3 shows the door-opening tool in the opened state. The two tool halves 16, 17 of the door-opening tool are attached to the two additional tool halves 18, 19. The tool halves 18, 19 form a preferably toothed cutting profile 37, 38 (see also FIG. 5), which makes it possible to cut through a door chain after the door or window is opened by means of the door-opening tool.

Furthermore, it can be seen from FIG. 3 that a preferably transversely extending nonslip contour 40a, 40b is provided—in the form of a knurl, for example—in the vicinity of the flattened or flat wall portion 20a of the tool half 16. It is provided so that a contact extension, such as a crowbar, for example, is provided with a hold and does not slip off. In addition, between the flattened rear-side region and the individual front-side wall portions 20b, the tool half 16 has a wall region 41 that is oriented at an angle in relation to the wall portions 20b and serves as a stop.

FIG. 4 shows an embodiment of the implement 1 according to the invention in which, instead of the door-opening tool of the embodiment according to FIGS. 1 to 3, a spreading tool with a triangular outer contour is located on the front side of the implement 1. This spreading tool possesses two tool halves 16, 17 and is also attached to the two tool halves 18, 19 in the aforedescribed manner. The type of locking is the same as in the embodiment of FIGS. 1 to 3. The toothed cutting profile 37, 38 of the two tool halves 18, 19 is readily visible.

As can be seen from FIG. 5, the tool halves 16, 17 have an outer surface 49, 50 in the outer region that can be preferably provided with a profile. Furthermore, the two tool halves 16, 17 each have a contact surface 35, 36 on the inside, which can also have a profile. The contact surface 35, 36 is interspersed with a cutting profile 44, 45 that extends to the tip of the two tool halves. The cutting profile 44, 45 is preferably rectilinear and can also project slightly over the plane of the contact surfaces 35, 36. As can be seen from FIG. 5, the cutting profile 44, 45 can lie in the extension of the cutting profile 37, 38 of the two tool halves 18, 19 to which the tool halves 16, 17 are attached.

The illustration according to FIG. 6 shows a partial representation of the pump housing 10, and of the control valve 8 without motor housing and with partially covered electric motor 23 inserted. The pump housing 10 has a ring-like projection 51 that serves to ensure a connection of the cylinder housing 22 to the pump housing 10. Also visible is the hollow rod 5 on the pump housing 10, which simultaneously serves as a line for the hydraulic fluid toward the second cylinder space 46b. Numeral 6 refers to additional hydraulic lines that lead from the pump housing 10 to the first cylinder space 46a (cf. FIG. 1).

The implement according to the invention has a hydraulic tank 4, which is accommodated in the pump housing 10. For this purpose, the pump housing 10 comprises an opening that can be closed by a lid 7 in which a compensating device is located, for example in the form of a cup-shaped rubber diaphragm 30. The lid 7 can be connected to the pump housing 10 using screws. The holding fixture 25 for the illumination unit to be mounted is located on the top side.

FIG. 7 shows an enlarged representation of the tank 4 of the implement. As can be seen, the lid 7 forms, together with the underlying pump housing 10, a compensation chamber 43 into which the compensating device in the form of the rubber diaphragm 30, for example, extends more or less depending on the position of the hydraulic cylinder 3. The pump housing 10 thus comprises a tank 4 that simultaneously represents the compensation volume 43 for the rubber diaphragm 30. In this way, the weight of the implement can be reduced substantially. An opening 48 is located in the lid 7 that makes it possible for air to escape into the compensation chamber 43 when the rubber diaphragm 30 expands.

FIG. 8 shows enlarged partial representations of a coupling 28 for manually locking and unlocking the tool halves 16, 17 to be attached to the tool halves 18, 19 in various states. FIG. 8a shows the locked tool halves, FIG. 8b shows the unlocked tool halves, and FIG. 8c shows the tool halves in the state of pushing-in or pushing-off.

FIG. 8a shows the second tool half 16, which is inserted into a recess 65 of the first tool half 18. FIG. 8a shows the locked state in which the second tool half 16 and the first tool half 18 are securely interconnected by the coupling 28. The coupling 28 comprises a large-surface, plate-shaped actuation element 56 that is located in a recess 57, a ring 58 (see FIG. 8b), and a locking element 53. The locking element 53 is located in a hole 54 of the tool half 16 and is biased by a spring 55 in the direction toward the actuation element 56.

In the embodiment shown here, the actuation element 56 has a preferably annular projection 60 that coacts with a correspondingly annular recess 62 so that the actuation element 56 can be pressed. Expediently, the actuation element 56 has an additional center projection 67 that lies opposite a hole 66 on the tool half 18. The hole 66 is expedient for creating space for the locking element 53 in order to lock the tool halves 16, 18 in place. The purpose of the projection 67 is, upon actuation of the actuation element 56, to displace the locking element 53 out of the hole 66 against the force of the spring 55 into the hole 54. This enables the coupling 28 to be unlocked. An annular projection 61 is located next to the hole 66. A corresponding recess 63 lies opposite the projection 61 in the actuation element 56. Upon actuation of the actuation element 56, the projection 61 is sunk into this recess 63. The actuation element 56 is thus guided.

FIG. 8b shows the unlocked state. The locking element 53 is completely sunk into the hole 54, and the actuation element 56 is pressed in by the operator. The actuation element 56 has an annular recess 59 on the outside. In the locked position (FIG. 8a), the recess 59 is filled by the ring 58, and an actuation plane of the actuation element 56 is thus created that is flush with the surface of the tool 18.

FIG. 8c clarifies how the second tool half 16 can be attached to the first tool half 18 and how they can be separated from one another. As a result of the force of the spring 55 during the retraction of the second tool half 16, the locking element 53 is pressed out of the hole 54 at the beginning of a chamfered edge 64 located on the first tool half 18. The chamfered edge acts as an insertion chamfer during the placement of the second tool half 16 onto the first tool half 18, and, during attachment, the locking element 53 is pressed by virtue of the chamfered edge 64 into the hole 54 and then plunged into same once the hole 66 is reached. In this way, the second tool half 16 is locked with the first tool half 18.

The implement according to the invention is characterized by a low weight and small dimensions. Moreover, it offers a very high level of variability of use and is therefore very especially suitable as an accompanying tool for firefighters that enables quick access into a building. The implement according to the invention is also very especially suitable for use by special task forces.

### LIST OF REFERENCE SYMBOLS

1 Implement

2 Hydraulic pump

3 Hydraulic cylinder

4 Hydraulic tank

5 Hollow rod

6 Hydraulic line

7 Lid

8 Control valve

9 Rechargeable battery

10 Pump housing

11 Piston rod

12 Pivoting arm

13 Pivoting arm

16 Second tool half

17 Second tool half

18 First tool half

19 First tool half

20 Portion

20a Wall portion

20b Wall portion

21 Portion

21a Wall portion

21b Wall portion

22 Cylinder housing

23 Electric motor

24 Flattened front region

25 Holding fixture for illumination unit

26 Harness support

27 Main switch

28 Coupling

29 Coupling

30 Rubber diaphragm

31 Handle

32 Protective cover

33 Harness support

34 Chamfer

35 Contact surface

36 Contact surface

37 Cutting profile

38 Cutting profile

39 Motor housing

40a Contour

40b Contour

41 Wall region

42 Flow opening

43 Compensation volume

44 Cutting profile

45 Cutting profile

46a First cylinder space

46b Second cylinder space

47 Hole

48 Lid opening

49 Outer surface

50 Outer surface

51 Annular projection

52 Pin

53 Locking element

54 Hole

55 Spring

56 Actuation element

57 Recess

58 Ring

59 Recess

60 Projection

61 Projection

62 Recess

63 Recess

64 Chamfered edge

65 Recess

66 Hole

67 Projection

1. A hydraulic implement for portable use, comprising a hydraulic pump, a pump housing, a hydraulic cylinder with piston rod,
a hydraulic tank, hydraulic lines, a compensation device, and a manually operable, hydraulic control valve,
a rechargeable battery accommodated on the implement,
two tool halves connected to the piston rod via pivoting arms , wherein the tool halves comprise spreading tool halves,
each spreading tool half has a wall portion extending perpendicular to the longitudinal axis of the piston rod , and, when the two spreading tool halves are in a closed state, the two wall portions form together a flattened front region running perpendicular to an extension of a longitudinal axis of the piston rod,
the flattened front region is oriented so as to be laterally offset and skewed in relation to the extension of the longitudinal axis of the piston rod and skewed to the extension of the longitudinal axis of the piston rod, wherein the tool halves have a cutting profile.

2. The implement as set forth in claim 1, wherein a tip of the flattened front region has a chamfer.

3. The implement as set forth in claim 1, wherein the spreading tool halves engage in or over one another in a vicinity of the flattened front region.

4. The implement as set forth in claim 3, wherein the spreading tool halves have a plurality of wall portions which, in lying one over the other, form the flattened front region.

5. The implement as set forth in claim 1, wherein the portion has at an end opposite the front region at least one flattened wall portion.

6. The implement as set forth in claim 5, wherein at least one flattened wall portion has at least one contour.

7. The implement as set forth in claim 1, wherein the spreading tool halves can be attached are attachable to pivoting arms.

8. The implement as set forth in claim 1, wherein the additional tool halves are attachable to the spreading tool halves.

9. The implement as set forth in claim 8, wherein a manual, toollessly operable coupling is provided between the spreading tool halves and the additional tool halves.

10. The implement as set forth in claim 8, wherein a spring-loaded locking element is accommodated in a hole in each of the spreading tool halves, and the additional tool halves each comprise a plate-shaped actuation element for the locking element.

11. The implement as set forth in claim 8, wherein the actuation element has a projection that lies opposite a hole on the additional tool halves, and the hole serves to receive the locking element in a locked state.

12. The implement as set forth in claim 8, wherein the additional tool half has a chamfered edge that acts as an insertion chamfer for the locking element.

13. The implement as set forth in claim 1, wherein the additional tool half has the cutting profile.

14. The implement as set forth in claim 1, wherein the cutting profile runs to a tip of the additional tool half.

15. The implement as set forth in claim 1, wherein a compensating device and a hydraulic tank are provided which are located in the pump housing.

16. The implement as set forth in claim 1, wherein the pump housing has a lid which, together with the pump housing, forms a compensation chamber into which the compensating device can extend.

17. The implement as set forth in claim 1, wherein a holding fixture for an illumination unit is located on the pump housing.
